(19) United States
(12) Patent Application Publication
(10) Pub. No.: US 2024/0211283 A1
(43) Pub. Date: Jun. 27, 2024

(54) VIRTUAL DESKTOPS ACCESS CONTROL

(71) Applicant: VMWARE, INC., Palo Alto, CA (US)

(72) Inventor: PRAJWAL PANCHMAHALKAR, McKinney, TX (US)

(21) Appl. No.: 18/087,848

(22) Filed: Dec. 23, 2022

(51) Int. Cl. G06F 9/451; G06F 9/455

(52) U.S. Cl. CPC G06F 9/452; G06F 9/45558; G06F 2009/45591; G06F 2009/45595

(57) ABSTRACT

An example client device may include a processor and memory coupled to the processor. The memory may include a client application to access a virtual desktop or a virtual application hosted on a remote server via a network. Further, the memory may include an access control module to monitor the client device while the client application is running and determine whether a predefined application is running in the client device based on the monitoring. In response to determining that the predefined application is running in the client device, the access control module may cause the client application to suspend access to the virtual desktop or the virtual application until the predefined application is terminated.

### TECHNICAL FIELD

The present disclosure relates to computing environments, and more particularly to methods, techniques, and systems for controlling access to virtual desktops in a computing environment.

### BACKGROUND

Virtual desktops and virtual applications provided as part of a virtual desktop infrastructure (VDI) or desktop-as-a-service (DAAS) offerings are becoming commonplace in today's enterprise work environments. The security of having a remotely stored desktop, ability to access the desktop from any location and on any device, centralized desktop management, efficient use of hardware resources, as well as numerous other benefits made possible by VDI/DAAS are a benefit for various organizations.

In a VDI or DAAS environment, each user in an enterprise may be provisioned a virtual environment and is allowed to access a provisioned virtual desktop or virtual application over a remote network connection, such as a wide area network (WAN) connection. The virtual environments are hosted on servers that reside in a data center of the enterprise (or a third-party service provider), and each host server may execute multiple virtual desktops. Users can utilize a client device to remotely log into their individual virtual desktop and all of the application execution takes place on the remote host server which is linked to the local client device over a network using a remote display protocol (e.g., a remote desktop protocol (RDP), a PC-over-IP protocol (PCoIP), a virtual network computing (VNC) protocol, or the like). Using the remote desktop protocol, the user can interact with the applications of the virtual desktop, which are running in the remote host server, with only the display, keyboard, and mouse information communicated with the client device.

### BRIEF DESCRIPTION OF THE DRAWINGS

FIG. 1 is a block diagram of an example system, depicting an access control module to control access to a virtual desktop or a virtual application;

FIG. 2 is a flow diagram illustrating an example method for controlling access to a virtual desktop or a virtual application;

FIG. 3A is an example graphical user interface of a client device, depicting a client application being executed in the client device;

FIG. 3B is an example graphical user interface of the client device, depicting the client application and a remote access program being executed in the client device;

FIG. 3C is an example graphical user interface of the client device, depicting the remote access program being accessed by a command-and-control server;

FIG. 3D is an example graphical user interface of the client device, depicting suspension of access to a virtual desktop session;

FIG. 3E is an example graphical user interface of the client device, depicting a notification including an option to terminate the remote access program;

FIG. 3F is another example graphical user interface of the client device, depicting a notification asking a user to terminate the remote access program;

FIG. 3G is an example graphical user interface of the client device, depicting restoring the access to the virtual desktop session;

FIG. 4 is a flow diagram illustrating another example method for controlling access to a virtual desktop; and

FIG. 5 is a block diagram of an example client device including non-transitory computer-readable storage medium storing instructions to control access to a virtual desktop.

The drawings described herein are for illustrative purposes and are not intended to limit the scope of the present subject matter in any way.

### DETAILED DESCRIPTION

Examples described herein may provide an enhanced computer-based and/or network-based method, technique, and system to control access to virtual desktops in a computing environment. The computing environment may be a virtual computing environment (e.g., a cloud computing environment, a virtualized environment, and the like). The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in virtual space being hosted by one or more physical data centers. The virtual computing environment may include multiple physical computers (e.g., servers) executing different computing-instances or workloads (e.g., virtual machines, containers, and the like). The workloads may execute different types of applications.

In such a virtualized environment, virtual desktops may be provided as part of virtual desktop infrastructure (VDI) or desktop-as-a-service (DAAS) offerings. A virtual desktop is executed on a virtual machine managed by a hypervisor executed on a server in a data center. In this example, the virtual desktop is an interface available to an individual user in the virtualized environment. For example, a desktop and application virtualization platform may provide a platform to run and deliver virtual desktops and applications across the hybrid cloud. An example desktop and application virtualization platform may be VMware Horizon™ offered by VMware®. With remote work, the desktop and application virtualization platform may provide a solution for organizations to enable work from anywhere in a secure and consistent desktop environment. With such desktop and application virtualization platforms, organizations may have the ability to configure, deploy, and manage desktops and applications at scale in a hybrid infrastructure. Additionally, VDIs can also be configured to enable isolated and secure access to corporate resources from any device, such as a laptop, thin client device, desktop personal computer, tablet, or phone.

For example, VMware Horizon™ VDIs may provide secure access to the virtual desktops with controls to manage security and access to the corporate resources. Further, the desktop and application virtualization platform may also provide secure VDIs which come configured with anti-virus or endpoint protection solutions (e.g., endpoint detection and response (EDR) and extended detection and response (XDR)) and hardened image templates. However, in some examples, the client device which is used to access the VDIs may be unmanaged or potentially at a risk due to no enforcement of security controls. In recent threat attacks targeting organizations, VDIs and virtual private networks (VPNs) are a significant part of the attack chain. Although secure VDIs provide an isolated and restricted access to the corporate resources, without control over the host environment, an attacker could potentially leverage remote administration tools (RATs) or remote desktop software installed on the client device to access the VDI and the applications. The recent trends of attackers utilizing RATs or remote desktop software on hostile desktops to access secure desktop environments expose gaps in the current security practices implemented through VPN or VDI solutions. Further, a compromised client device could also lead to unauthorized access to the VDI through the access trust established on the client device. For example, an attacker may take control of the AnyDesk application running in the client device through compromise and then take over the VDI through the AnyDesk application.

Examples described herein may provide a client device including an access control module to control access to a virtual desktop or a virtual application. The virtual desktop or the virtual application may be hosted on a remote server. The client device may include a client application to access the virtual desktop or the virtual application via a network. In an example, the access control module may monitor the client device while the client application is running. Further, the access control module may determine whether a predefined application (e.g., remote desktop software such as TeamViewer, AnyDesk, Splashtop Business Access, RemotePC, and the like) is running in the client device based on the monitoring. In response to determining that the predefined application (i.e., a predefined application process) is running in the client device, the access control module may cause the client application to suspend access to the virtual desktop or the virtual application until the predefined application process is terminated. Thus, the examples described herein may cause the remote desktop software, which is using VDI, unworkable, thereby ensuring security of the VDI environments.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

The terms “remote administration tool” (RAT), “remote desktop software”, and “remote access program” are used interchangeably throughout the document and refers to a program or an application that is used to access a desktop or desktop interface of a remote computer locally.

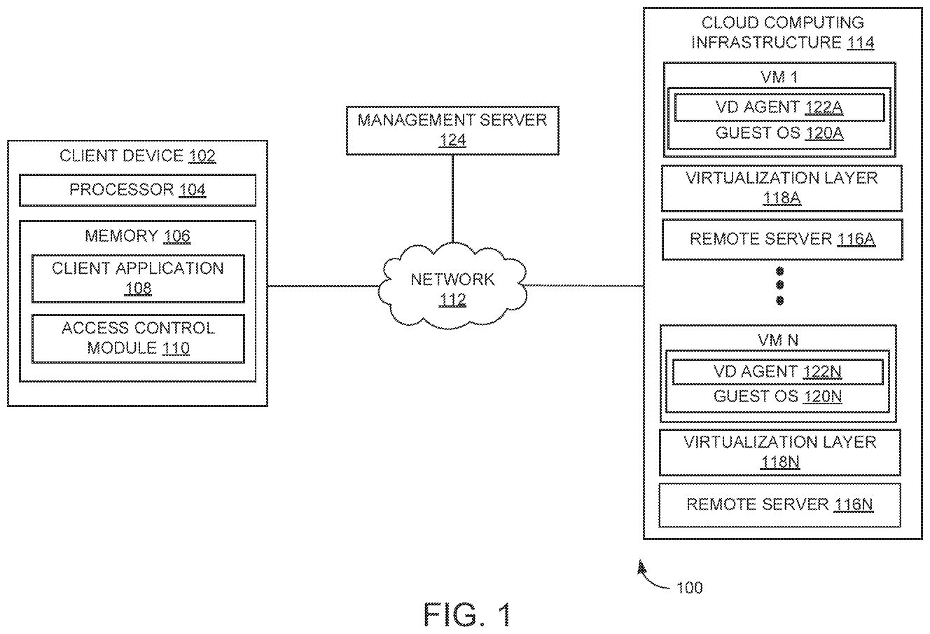

Referring now to the figures, FIG. 1 is a block diagram of an example system 100, depicting an access control module 110 to control access to a virtual desktop or a virtual application. Example system 100 represents a virtual desktop environment. The virtual desktop environment, such as a virtual desktop infrastructure (VDI) environment or a desktop-as-a-service (DAAS) environment, includes a cloud computing infrastructure 114 having multiple remote servers 116A-116N. For example, remote servers 116A-116N physically reside in a data center of an enterprise (e.g., in case of VDI) or in a data center of a third-party service provider (e.g., in case of DAAS). Further, each of remote servers 116A-116N may be a physical computer including an operating system (OS). Furthermore, remote servers 116A-116N may include respective virtualization layers 118A-118N that support execution of one or more virtual machines (e.g., VM 1 to VM N). An example virtualization layer (e.g., 118A) may be a hypervisor, a virtual machine manager (VMM), or other software that allows multiple virtual machines to share the physical resources of a remote server (e.g., 116A). In some examples, each virtual machine (e.g., VM 1 to VM N) can execute a guest operating system (e.g., 120A-120N) that hosts a virtual desktop (VD) agent (e.g., 122A-122N) for a user at a time.

Further, a remote server (e.g., 116A) can interoperate with a client device 102 to provide virtual desktop services (e.g., a virtual desktop or a virtual application) to the user of client device 102. Client device 102 may be a computing device (e.g., a thin client, a mobile device, or the like) including an operating system to execute different applications. In an example, client device 102 may execute a client application 108 to access the virtual desktop or the virtual application hosted on the remote server (e.g., 116A) via a network 112. An example client application is VMWare™ Horizon View™ client, which is a program that allows to connect a VMware Horizon virtual desktop to a client device. For example, a virtual desktop session associated with the virtual desktop may be executed on a virtual machine (e.g., VM 1) managed by a hypervisor (i.e., virtualization layer 118A) executed on a remote server (e.g., 116A) in cloud computing infrastructure 114. Further, the virtual machine (e.g., VM 1) may be assigned to the user and accessed via remote network 112.

Network 112 may be a managed Internet protocol (IP) network administered by a service provider. In an example, network 112 may be implemented using wireless protocols and technologies, such as Wi-Fi, WiMax, and the like. In other examples, network 112 can also be a packet-switched network such as a local area network, wide area network, metropolitan area network, Internet network, or other similar type of network environment. In yet other examples, network 112 may be a fixed wireless network, a wireless local area network (LAN), a wireless wide area network (WAN), a personal area network (PAN), a virtual private network (VPN), intranet or other suitable network system and includes equipment for receiving and transmitting signals.

Client application 108 can be a stand-alone, designated application (“native client”), or a web browser (“web client”). In some examples, a standard web browser may be modified with a plugin to operate as a web client. The interaction between the virtual desktop and client device 102 can be facilitated by client application 108 running in an operating system which communicates with remote server's (e.g., 116A) side virtual desktop agent (e.g., 122A) that is running in guest operating system (e.g., 120A). For example, the interaction can be performed by virtual desktop agent 122A transmitting encoded visual display information (e.g., framebuffer data) over network 112 to client application 108 and in turn transmitting user input events (e.g., keyboard, mouse events, and the like) to virtual desktop agent 122A. In this context, the terms “remote desktop” and “virtual desktop” refer to a computing environment in which the user can launch, interact with, and manage the user's applications, settings, and data. Further, client device 102 can allow the user to view on a graphical user interface (e.g., a local display device) his/her virtual desktop that is running remotely on remote server (e.g., 116A), as well as provide commands for controlling the virtual desktop. In this manner, the user of client device 102 can interact with the virtual desktop hosted on remote server (e.g., 116A) as if the virtual desktop was executing locally on client device 102.

As shown in FIG. 1, system 100 includes a management server 124 communicatively coupled to client device 102 and remote servers 116A-116N via network 112. Remote access to the virtual desktops is provided to client device 102 through management server 124. Management server 124 may provide access to the virtual desktops by client device 102 and manage the corresponding virtual machines through communications with a software interface of a virtual machine manager (VMM). The VMM may be responsible for provisioning and maintaining the multitude of virtual machines VM 1-VM N implemented across potentially a multitude of physical computers, such as remote servers 116A-116N. When a user wishes to access an existing virtual machine (e.g., VM 1), the user establishes a connection through management server 124, and the virtual desktop is presented (as a user interface) on client device 102, through which communications are made with the underlying virtual machine. For example, management server 124 may allow the user to select a type of virtual desktop and initiate a virtual desktop session or a connection to the virtual desktop using client device 102.

Further, client device 102 includes a processor 104 and a memory 106 coupled to processor 104. The term “processor” May refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 104 may, for example, include single or multiple cores on a chip, multiple cores across multiple chips, multiple cores across multiple devices, or suitable combinations thereof. Processor 104 may be functional to fetch, decode, and execute instructions as described herein.

Furthermore, memory 106 includes client application 108 and access control module 110. In an example, access control module 110 may be implemented as part of client application 108. During operation, access control module 110 may monitor client device 102 while client application 108 is running. Further, access control module 110 may determine whether a predefined application (i.e., a predefined application process) is running in client device 102 based on the monitoring. The predefined application may be a remote access program having an ability to enable remote access of client device 102 via a network connection (i.e., network 112). An example predefined application may include AnyDesk application, TeamViewer application, and the like. In another example, the predefined application can be a video conferencing application (e.g., a Zoom® meeting), a telecommunications application (e.g., Skype®), and the like.

In an example, access control module 110 may monitor processes running in client device 102 while client application 108 is running. A process or running process may refer to a set of instructions or an instance of a computer program currently being processed by processor 104 of client device 102. Further, access control module 110 may determine whether a process associated with the predefined application is running in client device 102 based on the monitored processes. In response to determining that the predefined application is running in client device 102, access control module 110 may cause client application 108 to suspend access to the virtual desktop or the virtual application until the predefined application is terminated.

Further, access control module 110 may provide an option on a graphical user interface of client device 102 seeking a user input to terminate the predefined application. In response to receiving the user input to terminate the predefined application, access control module 110 may terminate the predefined application. Upon terminating the predefined application, access control module 110 may cause client application 108 to restore the access to the virtual desktop or the virtual application.

In another example, access control module 110 may generate, at client device 102, a notification asking a user to terminate the predefined application. In response to detecting that the predefined application is terminated (e.g., manually), access control module 110 may cause client application 108 to restore the access to the virtual desktop or the virtual application.

Thus, when a remote access program such as AnyDesk application is identified to be running when client application 108 is connected to a secure virtual desktop, a process associated with client application 108 is suspended or made unusable until the remote access program process is terminated. In other words, the process associated with client application 108 will remain suspended until no processes associated with the remote access program are found to be running in client device 102. Thus, examples described herein may restrict threat agents from accessing secure resources provided through virtual desktops and ensure the security of resources managed through desktop and application virtualization platforms (e.g., VMware Horizon™, which is a platform for running and delivering virtual desktops and applications across a hybrid cloud).

In some examples, the functionalities described in FIG. 1, in relation to instructions to implement functions of client application 108, access control module 110, and any additional instructions described herein in relation to the storage medium, may be implemented as engines or modules including any combination of hardware and programming to implement the functionalities of the modules or engines described herein. The functions of client application 108 and access control module 110 may also be implemented by a processor. In examples described herein, the processor may include, for example, one processor or multiple processors included in a single device or distributed across multiple devices.

Further, the virtual desktop environment illustrated in FIG. 1 is shown purely for purposes of illustration and is not intended to be in any way inclusive or limiting to the embodiments that are described herein. For example, a typical enterprise VDI deployment would include many more remote servers, which may be distributed over multiple data centers, which might include many other types of devices, such as switches, power supplies, cooling systems, environmental controls, and the like, which are not illustrated herein. Similarly, a single remote server would host many more virtual machines than what is shown in this illustration. It will be apparent to one of ordinary skill in the art that the example shown in FIG. 1, as well as all other figures in this disclosure have been simplified for ease of understanding and are not intended to be exhaustive or limiting to the scope of the idea.

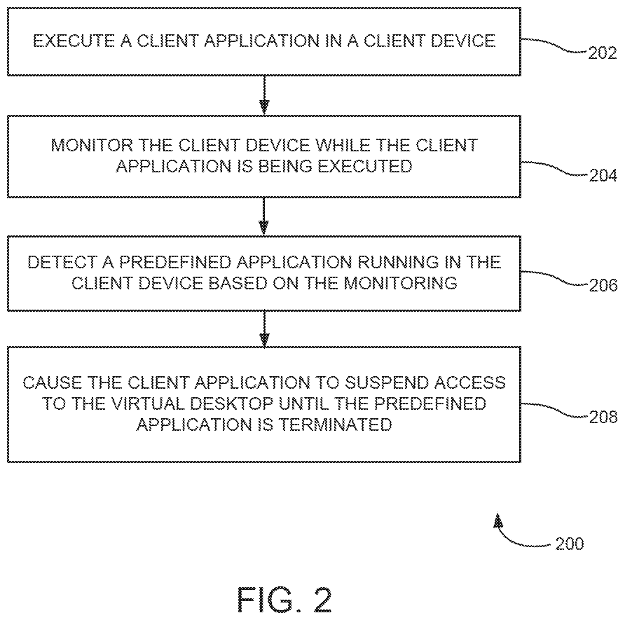

FIG. 2 is a flow diagram illustrating an example method 200 for controlling access to a virtual desktop. Example method 200 depicted in FIG. 2 represents generalized illustrations, and other processes may be added, or existing processes may be removed, modified, or rearranged without departing from the scope and spirit of the present application. In addition, method 200 may represent instructions stored on a computer-readable storage medium that, when executed, may cause a processor to respond, to perform actions, to change states, and/or to make decisions. Alternatively, method 200 may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but the flow chart illustrates functional information to design/fabricate circuits, generate computer-readable instructions, or use a combination of hardware and computer-readable instructions to perform the illustrated processes.

At 202, a client application may be executed in a client device. In an example, the client application may be configured to access a virtual desktop session with a virtual desktop hosted on a remote server over a network connection. At 204, the client device may be monitored by an access control module of the client application while the client application is being executed. In an example, monitoring the client device may include monitoring processes running in the client device while the client application is being executed.

At 206, a predefined application running in the client device may be detected by the access control module based on the monitoring. In an example, detecting the predefined application running in the client device may include detecting a process associated with the predefined application running in the client device based on the monitored processes. An example predefined application may include a remote access program or a remote administration tool (RAT). In response to detecting the predefined application running in the client device, at 208, the client application may be caused to suspend access to the virtual desktop session until the predefined application is terminated.

Upon causing the client application to suspend access to the virtual desktop session, an option may be provided on a graphical user interface of the client device seeking a user input to terminate the predefined application. In response to receiving the user input to terminate the predefined application, the predefined application may be terminated. Upon terminating the predefined application, the client application may be caused to restore the access to the virtual desktop session.

In another example, a notification asking a user to terminate the predefined application may be generated at the client device. In response to detecting that the predefined application is terminated, the client application may be caused to restore the access to the virtual desktop session.

Thus, examples described herein may provide a restricted mode to secure VDIs through restriction of the remote access programs when the client application is connected to a secure VDI. Examples described herein may provide a standalone script (e.g., the access control module) to continuously monitor a process list on the client device (e.g., an unmanaged host system) when the client application (e.g., VMWare™ Horizon View™ client) is running. When a remote access program (e.g., AnyDesk application) is found to be running, the script immediately suspends the process associated with the client application, thereby restricting any access to the VDI resources and ensuring secure access control to the VDI resources. Further, the script may prompt the user about the restricted mode constraints and to terminate the remote access program processes to continue access to the VDI. As soon as the script detects no remote access programs are running in the client device, access to the virtual desktop may be restored and the process associated with the client application may be resumed.

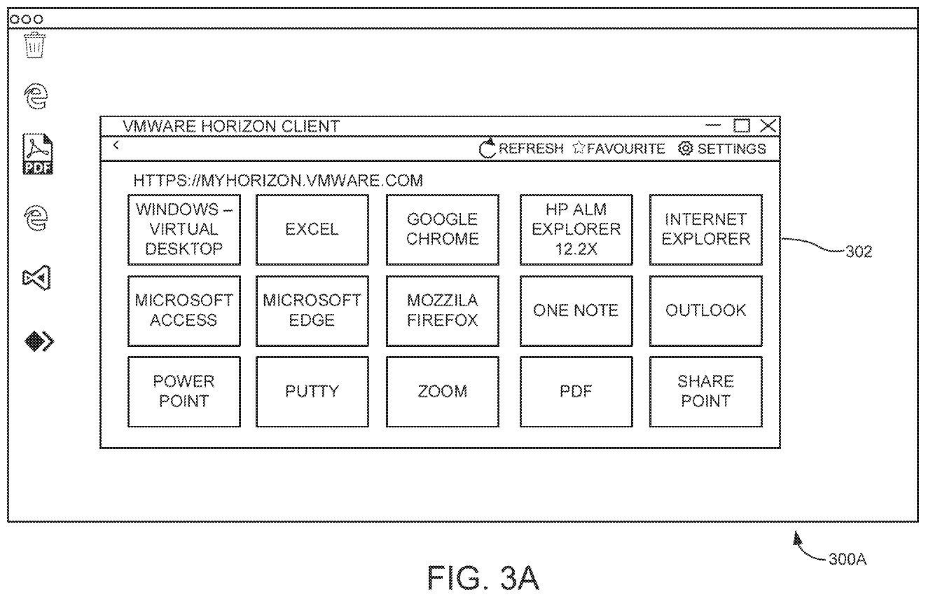

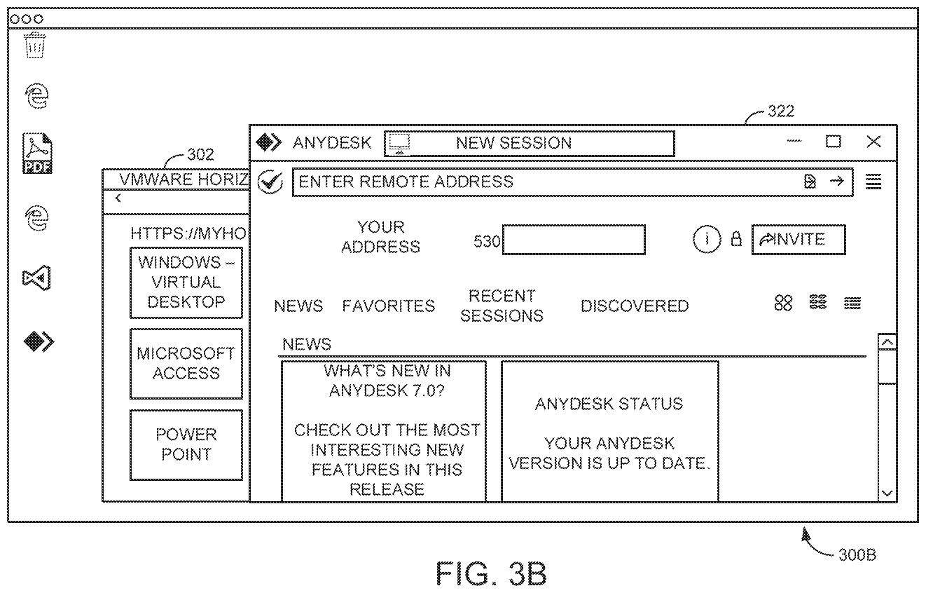

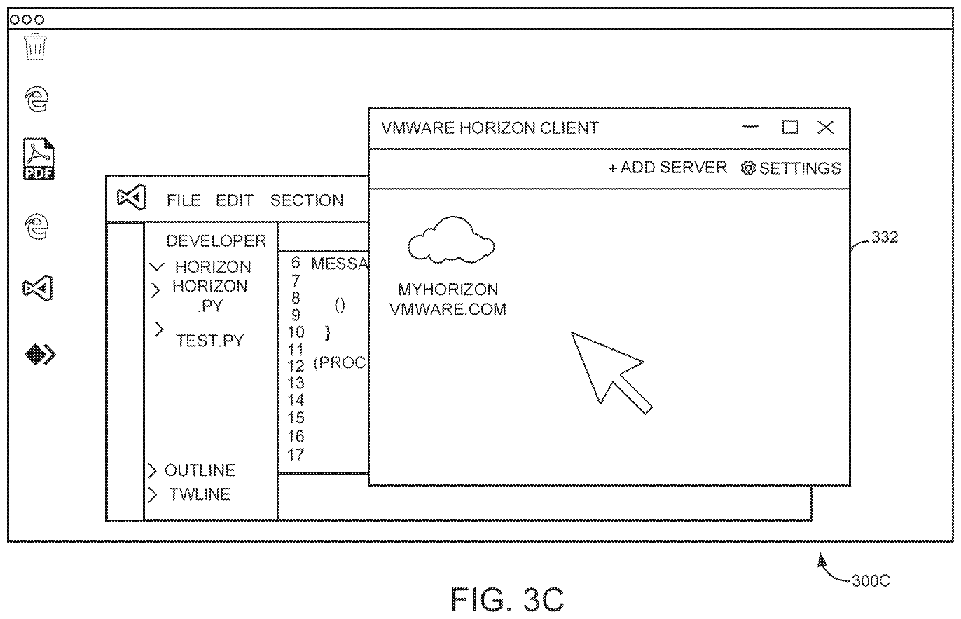

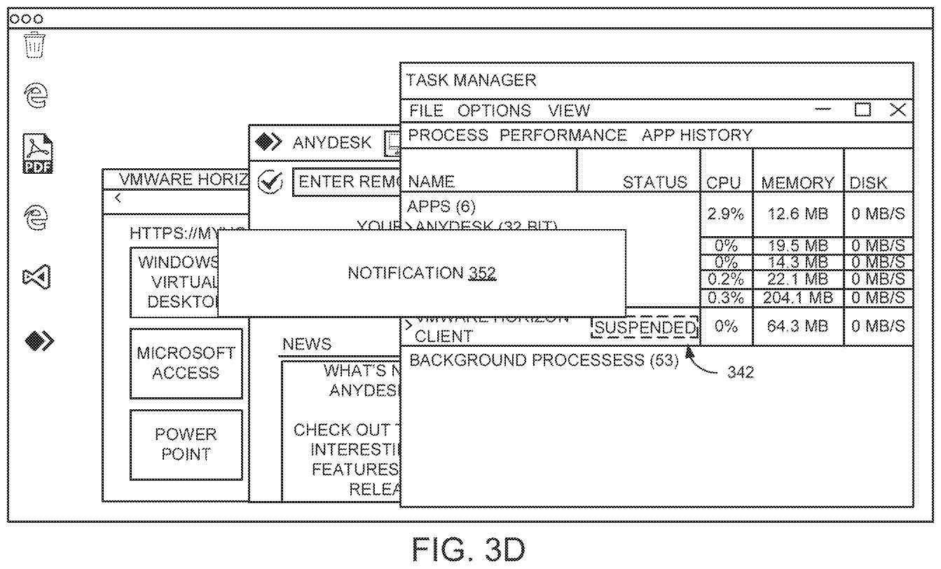

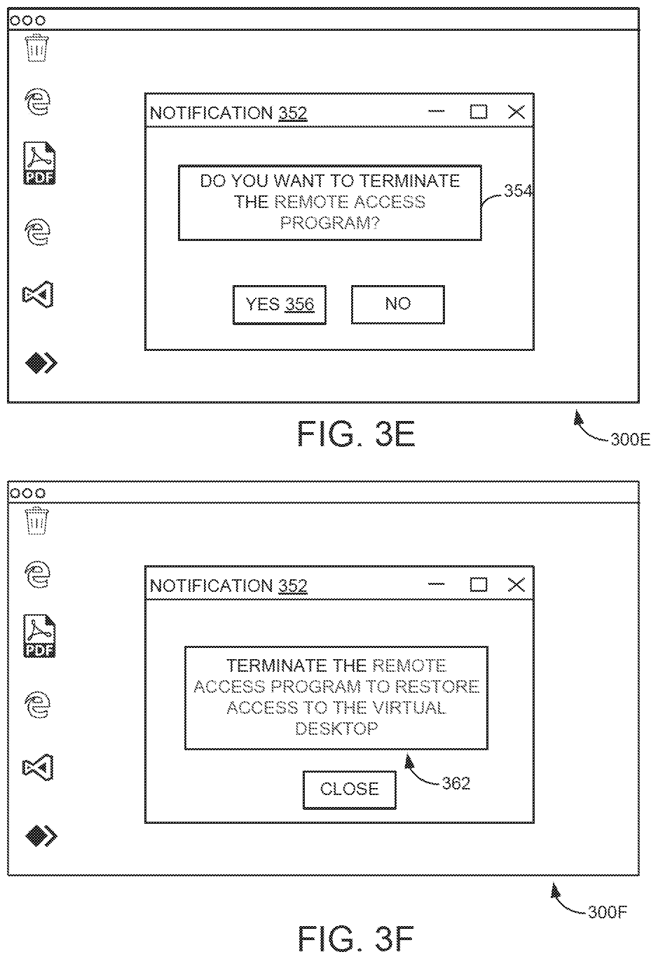

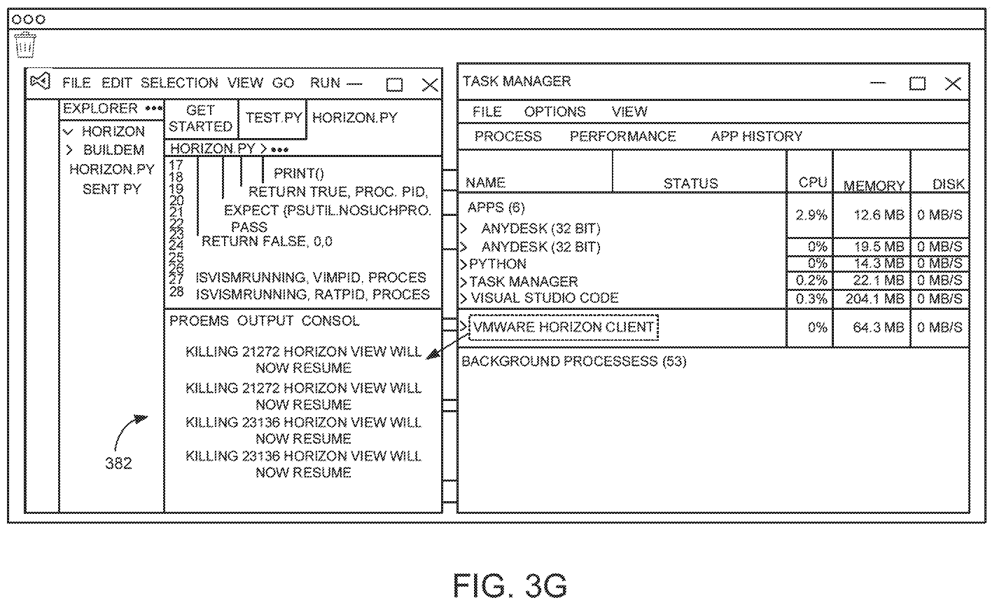

FIG. 3A is an example graphical user interface 300A of a client device, depicting a client application 302 being executed in the client device. For example, consider that a Windows 11 development environment is setup as the client device, which may act as an unmanaged hostile setup. The client device may be installed with client application 302 (i.e., VMWare™ Horizon View™ client) and a remote access program (e.g., an AnyDesk™ application). As shown in FIG. 3A, client application 302 is executed to connect to a remote server (e.g., a VMWARE View Horizon server, which is a physical host computing system to create and manage the virtual machines) and launch a virtual desktop session. As described above, the virtual desktop session may be executed in a virtual machine managed by a hypervisor executed on the remote server. Client application 302 may allow the user to view on graphical user interface 300A of the client device (e.g., a local display device) his/her virtual desktop session that is running remotely on the remote server, as well as provide commands for controlling the virtual desktop session.

FIG. 3B is an example graphical user interface 300B of the client device, depicting client application 302 and a remote access program 322 (e.g., an “AnyDesk” application) being executed in the client device. As shown in FIG. 3B, “AnyDesk” application 322 is launched in the client device while client application 302 is being executed in the client device. Further, consider that “AnyDesk” application 322 is connected to a command-and-control server (e.g., a computer controlled by an attacker or cybercriminal which is used to send commands to the client device compromised by malware and receive stolen data from a target network).

FIG. 3C is an example graphical user interface 300C of the client device, depicting remote access program 322 being accessed by the command-and-control server. In the example shown in FIG. 3C, “AnyDesk” application 322 may act as a threat actor and connected to the command-and-control server. In this example, consider that the client device is compromised, and the attacker is controlling “AnyDesk” application 322 (e.g., as shown by 332). The attacker may take control of “AnyDesk” application 322 through compromise and takes over client application 302 through “AnyDesk” application 322. Thus, the attacker can launch “AnyDesk” application in their command-and-control server providing full access to the virtual desktop session of the client device without restrictions.

FIG. 3D is an example graphical user interface 300D of the client device, depicting suspension of access to the virtual desktop session (i.e., suspension of a process associated with client application 302). To overcome the drawback described in FIG. 3C, examples described here may provide a proof of concept (PoC) script, which when launched enforces a restricted mode. The PoC script may detect that the remote access program “AnyDesk” application 322 is running alongside client application 302, and suspends the process associated with client application 302 (e.g., as shown in 342). Thus, the virtual desktop session may be secured from further access. Also, a notification 352 prompting the user to kill “AnyDesk” application 322 may be generated. An example notification 352 is shown in FIGS. 3E and 3F. Further, the process associated with client application 302 (i.e., the virtual desktop session) may remain suspended until “AnyDesk” application 322 is terminated.

FIG. 3E is an example graphical user interface 300E of the client device, depicting notification 352 including an option 354 to terminate remote access program 322. As shown in FIG. 3E, graphical user interface 300E displays option 354 to seek a user input to terminate remote access program “AnyDesk” application 322. For example, when an option 356 “yes” is selected by the user, “AnyDesk” application 322 may be terminated. Further, in response to receiving the user input to terminate “AnyDesk” application 322 , “AnyDesk” application 322 may be terminated and access to the virtual desktop session may be restored.

FIG. 3F is another example graphical user interface 300F of the client device, depicting notification 352 asking a user to terminate remote access program 322. As shown in FIG. 3F, notification 352 displays a message 362 asking a user to terminate “AnyDesk” application 322. Further, in response to detecting that “AnyDesk” application 322 is terminated manually, access to the virtual desktop session may be restored.

FIG. 3G is an example graphical user interface 300G of the client device, depicting restoring the access to the virtual desktop session (i.e., restoring the process associated with client application 302). For example, upon the user terminating “AnyDesk” application 322 by clicking button “yes” 356 of FIG. 3E on the prompt or manually terminating “AnyDesk” application 322, the process associated with client application 302 may be restored and access to the virtual desktop session may be resumed for the user to continue with operations as shown in 382. Thus, examples described herein, when implemented as feature in the client application, identifies secure VDIs and implements the security restriction as described above, which reduces attack surface for corporations by breaking the chain of attacks.

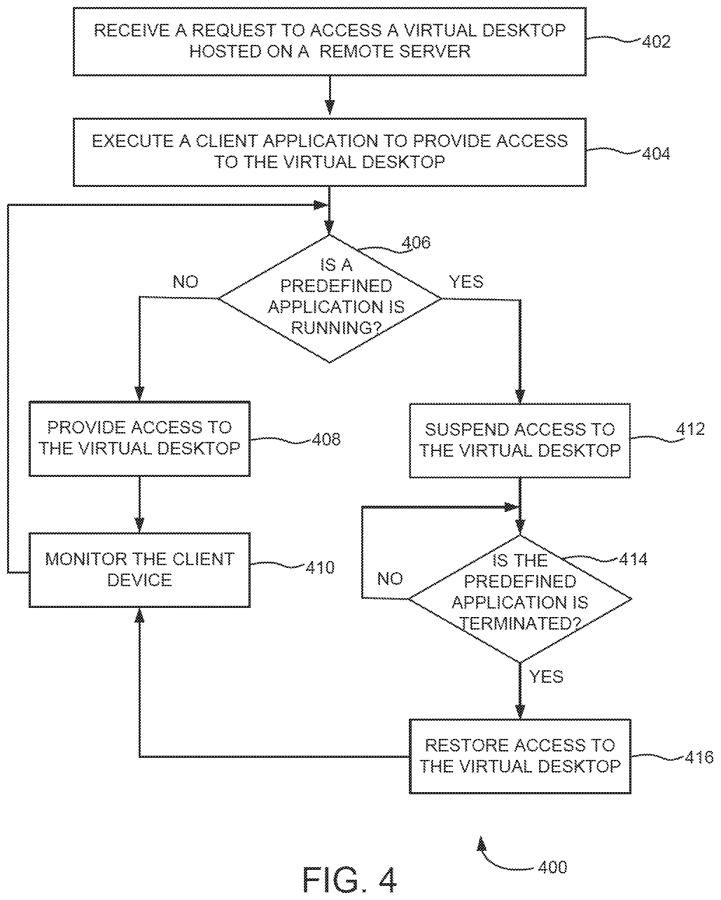

FIG. 4 is a flow diagram illustrating another example method 400 for controlling access to a virtual desktop. Example method 400 depicted in FIG. 4 represents generalized illustrations, and other processes may be added, or existing processes may be removed, modified, or rearranged without departing from the scope and spirit of the present application. In addition, method 400 may represent instructions stored on a computer-readable storage medium that, when executed, may cause a processor to respond, to perform actions, to change states, and/or to make decisions. Alternatively, method 400 may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but the flow chart illustrates functional information to design/fabricate circuits, generate computer-readable instructions, or use a combination of hardware and computer-readable instructions to perform the illustrated processes.

At 402, a request to access a secure virtual desktop hosted on a remote server may be received. At 404, a client application may be executed to provide access to the virtual desktop. At 406, a check may be made to determined whether a predefined application (e.g., a remote access program) is running in the client device.

When the predefined application is not running in the client device, access to the secure virtual desktop may be provided, at 408. At 410, the client device may be monitored (e.g., at defined intervals) to determine whether the predefined application is running in the client device. When the predefined application is running in the client device, access to the virtual desktop may be suspended, at 412.

At 414, a check may be made to determine whether the predefined application is terminated. When the predefined application is not terminated, access to the secure virtual desktop may be suspended until the process associated with the predefined application is terminated. When the predefined application is terminated, access to the secure virtual desktop may be restored, at 416. Further, the client device may be monitored to determine whether the predefined application is running in the client device, at 410.

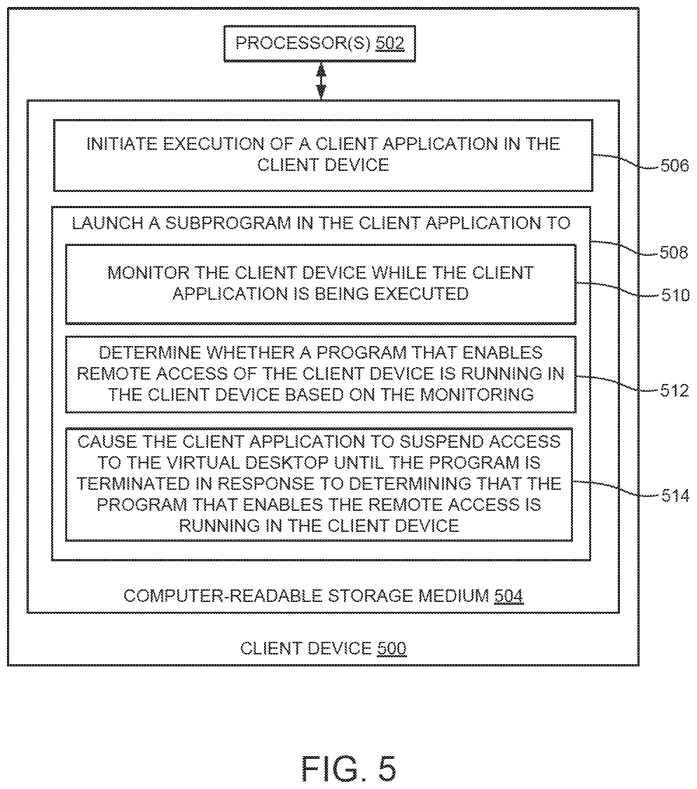

FIG. 5 is a block diagram of an example client device 500 including non-transitory computer-readable storage medium 504 storing instructions to control access to a virtual desktop. Client device 500 may include a processor 502 and computer-readable storage medium 504 communicatively coupled through a system bus. Processor 502 may be any type of central processing unit (CPU), microprocessor, or processing logic that interprets and executes computer-readable instructions stored in computer-readable storage medium 504. Computer-readable storage medium 504 may be a random-access memory (RAM) or another type of dynamic storage device that may store information and computer-readable instructions that may be executed by processor 502. For example, computer-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 504 may be a non-transitory computer-readable medium. In an example, computer-readable storage medium 504 may be remote but accessible to client device 500.

Computer-readable storage medium 504 may store instructions 506, 508, 510, 512, and 514. Instructions 506 may be executed by processor 502 to initiate execution of a client application on client device 500. In an example, the client application may establish a session to a virtual desktop associated with a user of client device 500 and the session may allow client device 500 to remotely access the virtual desktop hosted on a remote server.

Instructions 508 may be executed by processor 502 to launch a subprogram in the client application. Instructions 510 may be executed by processor 502 to monitor the client device while the client application is being executed upon launching the subprogram. In an example, instructions 510 to monitor the client device may include instructions to monitor processes running in client device 500 while the client application is running.

Instructions 512 may be executed by processor 502 to determine whether a program that enables remote access of the client device is running in the client device based on the monitoring. In an example, instructions to determine whether the program that enables remote access of the client device is running may include instructions to determine whether a process associated with the program that enables remote access of client device 500 is running in client device 500 based on the monitored processes. An example program to enable remote access of client device 500 is selected from predefined programs. The predefined program may include a remote administration tool (RAT).

In response to determining that the program that enables the remote access is running in client device 500, instructions 514 may be executed by processor 502 to cause the client application to suspend access to the virtual desktop until the program is terminated.

In an example, computer-readable storage medium 504 may include instructions to provide an option on a graphical user interface of client device 500 seeking a user input to terminate the program. In response to receiving the user input to terminate the program, computer-readable storage medium 504 may include instructions to terminate the program and cause the client application to restore the access to the virtual desktop upon terminating the program.

In another example, computer-readable storage medium 504 may include instructions to generate a notification asking a user to terminate the program at the client device. In response to detecting that the program is terminated, computer-readable storage medium 504 may include instructions to cause the client application to restore the access to the virtual desktop.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A client device comprising:
a processor; and
memory coupled to the processor, wherein the memory comprises:
a client application to access a virtual desktop or a virtual application hosted on a remote server via a network; and
an access control module to:
monitor the client device while the client application is running;
determine whether a predefined application is running in the client device based on the monitoring; and
in response to determining that the predefined application is running in the client device, cause the client application to suspend access to the virtual desktop or the virtual application until the predefined application is terminated.

2. The client device of claim 1, wherein the access control module is to:
provide an option on a graphical user interface of the client device seeking a user input to terminate the predefined application.

3. The client device of claim 2, wherein the access control module is to:
in response to receiving the user input to terminate the predefined application:
terminate the predefined application; and
upon terminating the predefined application, cause the client application to restore the access to the virtual desktop or the virtual application.

4. The client device of claim 1, wherein the access control module is to:
generate, at the client device, a notification asking a user to terminate the predefined application.

5. The client device of claim 4, wherein the access control module is to:
in response to detecting that the predefined application is terminated, cause the client application to restore the access to the virtual desktop or the virtual application.

6. The client device of claim 1, wherein the access control module is to:
monitor processes running in the client device while the client application is running; and
determine whether a process associated with the predefined application is running in the client device based on the monitored processes.

7. The client device of claim 1, wherein the access control module is implemented as part of the client application.

8. The client device of claim 1, wherein the predefined application is a remote access program having an ability to enable remote access of the client device via a network connection.

9. A method comprising:
executing a client application on a client device, the client application being configured to access a virtual desktop session with a virtual desktop hosted on a remote server over a network connection;
monitoring, by an access control module of the client application, the client device while the client application is being executed;
detecting, by the access control module, a predefined application running in the client device based on the monitoring; and
in response to detecting the predefined application running in the client device, causing the client application to suspend access to the virtual desktop session until the predefined application is terminated.

10. The method of claim 9, further comprising:
upon causing the client application to suspend access to the virtual desktop session, providing an option on a graphical user interface of the client device seeking a user input to terminate the predefined application; and
in response to receiving the user input to terminate the predefined application:
terminating the predefined application; and
upon terminating the predefined application, causing the client application to restore the access to the virtual desktop session.

11. The method of claim 9, further comprising:
generating, at the client device, a notification asking a user to terminate the predefined application; and
in response to detecting that the predefined application is terminated, causing the client application to restore the access to the virtual desktop session.

12. The method of claim 9, wherein monitoring the client device comprises:
monitoring processes running in the client device while the client application is being executed, and wherein detecting the predefined application running in the client device comprises:
detecting a process associated with the predefined application running in the client device based on the monitored processes.

13. The method of claim 9, wherein the predefined application comprises a remote administration tool (RAT).

14. A non-transitory computer-readable storage medium having instructions executable by a processor of a client device to:
initiate execution of a client application on the client device, the client application establishing a session to a virtual desktop associated with a user of the client device and the session allowing the client device to remotely access the virtual desktop hosted on a remote server; and
upon initiating execution of the client application, launch a subprogram in the client application to:
monitor the client device while the client application is being executed;
determine whether a program that enables remote access of the client device is running in the client device based on the monitoring; and
in response to determining that the program that enables the remote access is running in the client device, cause the client application to suspend access to the virtual desktop until the program is terminated.

15. The non-transitory computer-readable storage medium of claim 14, further comprising instructions to:
provide an option on a graphical user interface of the client device seeking a user input to terminate the program.

16. The non-transitory computer-readable storage medium of claim 15, further comprising instructions to:
in response to receiving the user input to terminate the program:
terminate the program; and
upon terminating the program, cause the client application to restore the access to the virtual desktop.

17. The non-transitory computer-readable storage medium of claim 14, further comprising instructions to:
generate, at the client device, a notification asking a user to terminate the program; and
in response to detecting that the program is terminated, cause the client application to restore the access to the virtual desktop.

18. The non-transitory computer-readable storage medium of claim 14, wherein instructions to monitor the client device comprise instructions to:
monitor processes running in the client device while the client application is running, and wherein instructions to determine whether the program that enables remote access of the client device is running comprise instructions to:
determine whether a process associated with the program that enables remote access of the client device is running in the client device based on the monitored processes.

19. The non-transitory computer-readable storage medium of claim 14, wherein the program that enables remote access of the client device is selected from predefined programs.

20. The non-transitory computer-readable storage medium of claim 14, wherein the program comprises a remote administration tool (RAT).
